(19) United States
(12) Patent Application Publication
(10) Pub. No.: US 2017/0004539 A1
(43) Pub. Date: Jan. 5, 2017

(54) AUDIOVISUAL MEDIA AND ADVERTISEMENT SPLICING PLATFORM

(71) Applicant: Jennifer G. Jackson, West Hollywood, CA (US)

(72) Inventor: Jennifer G. Jackson, West Hollywood, CA (US)

(21) Appl. No.: 15/199,306

(22) Filed: Jun. 30, 2016

Related U.S. Application Data
(60) Provisional application No. 62/187,996, filed on Jul. 2, 2015.

(51) Int. Cl. G06Q 30/02; H04L 29/08

(52) U.S. Cl. CPC G06Q 30/0269; H04L 67/02; H04L 67/10; H04L 67/146; G06Q 30/0277

(57) ABSTRACT

Embodiments of the disclosure many enable users to post content, such as, for example, images, video, and audio content, with hashtags. Further, embodiments of the present disclosure may enable advertisers to create advertising campaigns that may comprise, for example, one or more images, audiovisual content and hashtags associated with the advertising campaign. When the platform receives user content and hashtags that correspond with a hashtag associated with an advertising campaign, the platform may integrate the content posted by the user with the content of the advertising campaign. The platform may then publish the integrated content to various viewers on various platforms. The platform may track impressions and views for the publication and, in some embodiments, the platform may transfer funds from an account associated with the advertiser to an account associated with the user in exchange for the advertiser employing the user's content in receiving impressions for the advertisement campaign.

### RELATED APPLICATION

Under provisions of 35 U.S.C. §119(e), the Applicant claims the benefit of US Provisional Patent Application No. 62/187,996 filed on Jul. 2, 2015, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to content sharing on social media.

### BACKGROUND

Individuals and brand advertisers (“posters”) often post audiovisual content on social media. For example, individuals post images, videos, and comments to a plurality of social media applications (e.g., Facebook, YouTube, Instagram, Twitter, and Vine). Further, individuals often incorporate “hashtags,” a metadata tag created by posting unspaced text preceded by a hash character (i.e. number sign/pound sign/octothorpe), which enable, among other things, the content to be searchable. In some instances, hashtags may be inserted automatically via certain applications. In most circumstances, the content and hashtags are posted without any expectation of direct monetary gain for the poster.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of the present disclosure many enable users to post content, such as, for example, images, video, and audio content, with hashtags. Further, embodiments of the present disclosure may enable advertisers to create advertising campaigns that may comprise, for example, one or more images, audiovisual content and hashtags associated with the advertising campaign. When the platform receives user content and hashtags that correspond with a hashtag associated with an advertising campaign, the platform may integrate the content posted by the user with the content of the advertising campaign.

Still consistent with various embodiments, the platform may then publish the integrated content to various viewers on various platforms. The platform may track impressions and views for the publication and, in some embodiments, the platform may transfer funds from an account associated with the advertiser to an account associated with the user in exchange for the advertiser employing the user's content in receiving impressions for the advertisement campaign.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing an audiovisual media and advertisement splicing platform;

FIG. 3 illustrates a dashboard for displaying an advertiser's advertising campaigns;

FIG. 4 illustrates a dashboard for editing an advertising campaign;

FIG. 5 illustrates another dashboard for editing an advertising campaign;

FIG. 6 illustrates a dashboard for enabling users to view content from variety of sources;

FIG. 7 illustrates a feed of content provided to a viewer; and

FIG. 8 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of audiovisual content, embodiments of the present disclosure are not limited to use only in this context. For example, any applicably-shareable content may be provided using this platform.

### I. Platform Overview

Consistent with embodiments of the present disclosure, an audiovisual media and advertisement splicing platform may be provided. This overview is provided to introduce a selection of concepts in a simplified form that are further described below. This overview is not intended to identify key features or essential features of the claimed subject matter. Nor is this overview intended to be used to limit the claimed subject matter's scope.

In one aspect of the present disclosure, the platform may be used by individuals or companies to integrate shared content with content from an advertiser and provide the integrated content to viewers in exchange for payment.

Embodiments of the present disclosure may receive content from a user (e.g., several 10-second video clips) and a hashtag. The platform may then integrate the shared content from the user with advertising content (e.g., an image or video of a product for sale) from an advertising campaign associated with the same hashtag. For example, the platform may splice the clips together into a single video clip, with each 10-second clip separated by a short display of the image from the advertising content. The integrated content (e.g., spliced clip) may be provided to viewers. Every time content is provided to a viewer, the platform may transfer payment from an account associated with the advertising campaign to the user who shared the content.

The platform may limit the number of times the advertising content is provided (each provision comprising an ‘impression’) to a number predetermined by the advertiser. For example, the advertiser may set a campaign to have 10,000 impressions. After the advertising content has been provided 10,000 times, the platform may stop providing the advertised content and transferring payment unless the advertiser purchases additional ‘impressions’.

Embodiments of the present disclosure may receive content from users, such as, for example, video clips, audio clips, and images, and one or more hashtags. The platform may provide the user with tools to modify and edit the provided content. For example, the platform may enable the user to apply filters, pan across an image, crop video and images, add or modify sound (e.g., cause the platform to play an audio clip as an image is displayed), arrange the presentation order of the content, etc. In some embodiments, the platform may enable users to share up to four 10-second clips per integrated content sharing.

The platform may further receive an advertising campaign. An advertising campaign may include a campaign name, associated hashtag or hashtags, and advertising content. For example, the advertising content may be an image, audio clip, or video clip. The advertising campaign may further be associated with a number of impressions. This may limit the number of times that an advertising campaign may be shared with users. Further, the advertising campaign may be comprised of impression restrictions. The impression restrictions may limit which users may provide content associated with the advertising campaign. In this way, the advertiser may select users most likely to provide content relevant to its advertising campaign. Moreover, the impression restrictions may limit which users receive content associated with the advertisement campaign. In this way, the advertiser may choose an ideal demographic to whom it desires to advertise. For example, impression restrictions may include, but not be limited to, specified usernames, one or more locations, a date range, an age range, a specified gender, and various other user demographics.

Once the platform receives shared content from the user and an advertising campaign with a matching hashtag, the platform may integrate the shared content from the user and the advertising campaign. The integrated content may be, for example, video clips from the user spliced together with a brief image of an advertiser's product in between each clip. The integrated content may be provided to users, via, for example, a mobile application. The mobile application may display the integrated content in, for example, a newsfeed.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

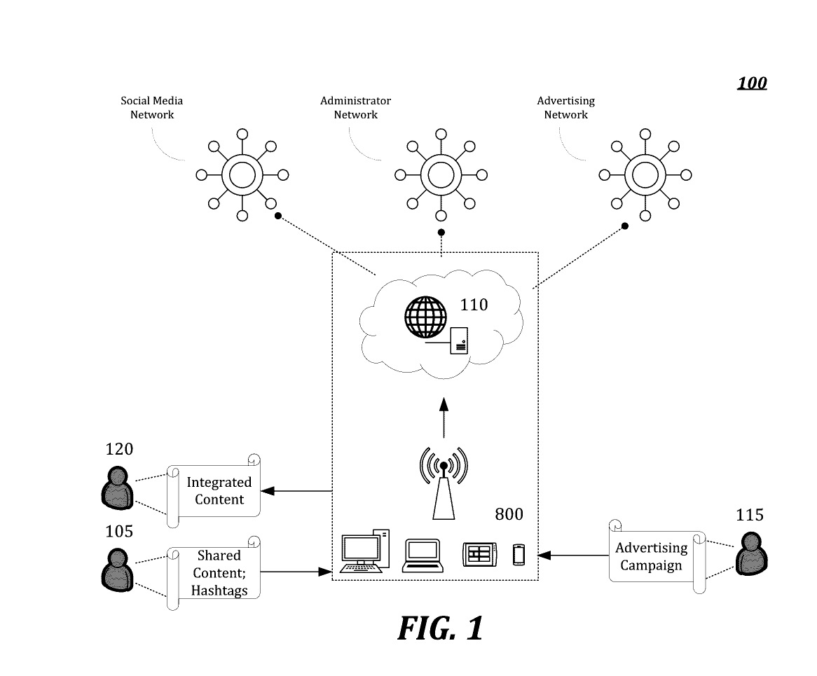

FIG. 1 illustrates one possible operating environment through which a platform consistent with embodiments of the present disclosure may be provided. By way of non-limiting example, a platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 800. One possible embodiment of the software application may be provided under the tradename HASHFLASH®. Similarly, a viewer 120 may view content via a website or application compatible with a computing device 800. In various other embodiments, platform 100 may be an existing social media or online media platform having integrated various embodiments of the present disclosure.

User 105 may use computing device 800 to communicate with server 110 through a user interface. The user interface may enable user 105 to input content for sharing, such as, for example, audiovisual content and hashtags. The user interface may further enable viewer 120 to view content. In some embodiments, viewer 120 and user 105 may be the same individual. An advertiser 115 may use an advertiser user interface to communicate with server 110 and input advertising campaign content, as further discussed below.

Centralized server 110 may be configured to receive user content and advertising campaign content. The content may be received from user 105 or from a third party platform associated with user 105 (e.g., YouTube, Facebook, Twitter, Instagram, and the like.) The centralized server 110 may then be configured to integrate the user content and advertising campaign content in accordance to the various embodiments described herein. The integrated content (also referred to as the ‘combined’ content) may then be provided to viewer 120 via the user interface. In other embodiments, the integrated content may be published to a third party platform (e.g., the third party platform from which the first content was received).

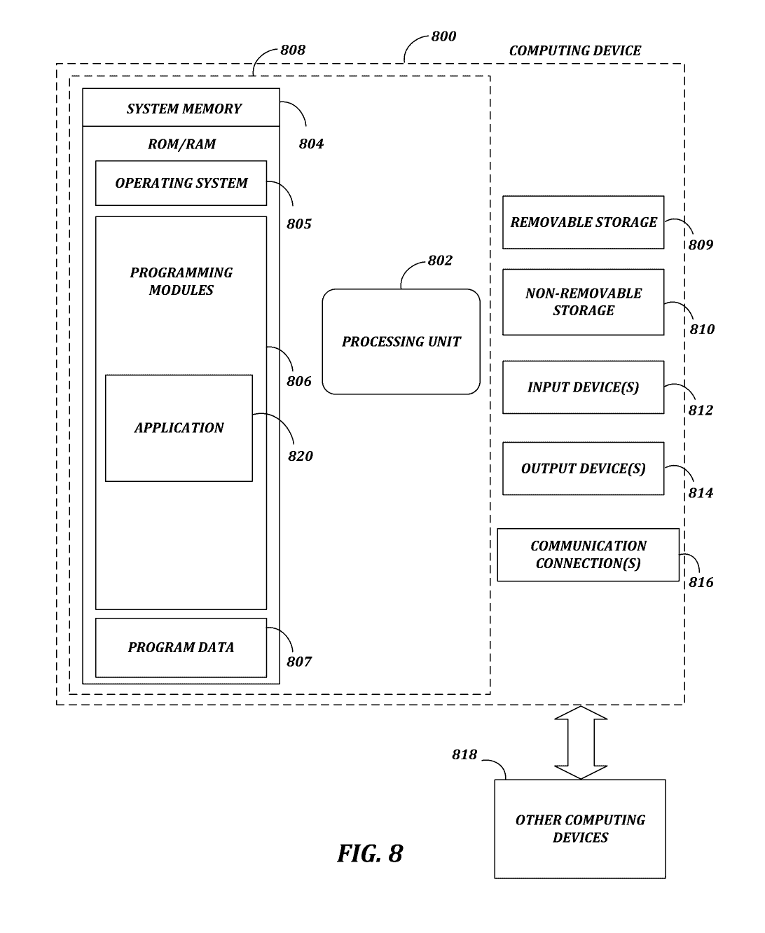

As will be detailed with reference to FIG. 8 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

### III. Platform Operation

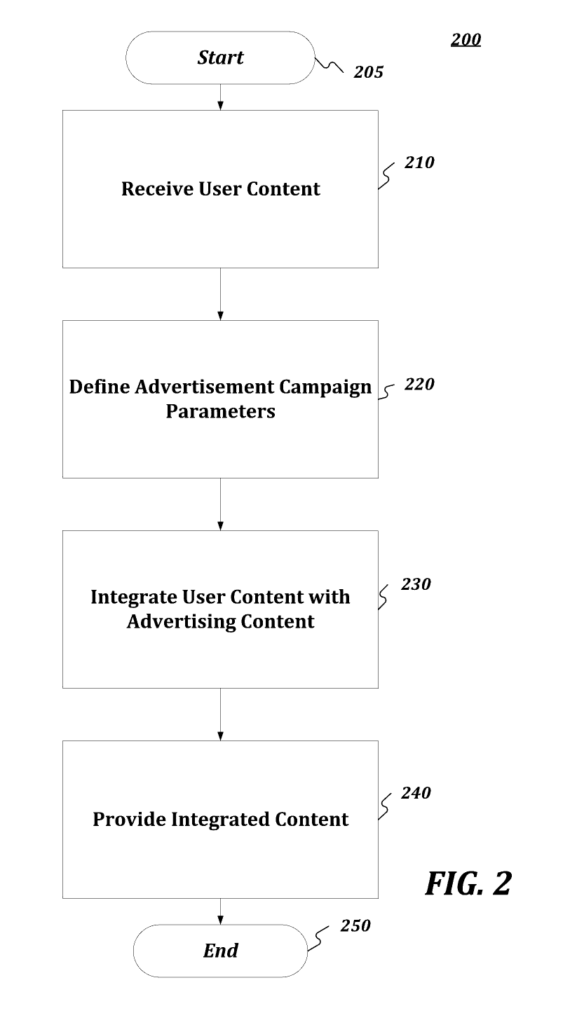

FIG. 2 is a flow chart setting forth the general stages involved in a method 200 consistent with an embodiment of the disclosure for providing platform 100. Method 200 may be implemented using a computing device 800 as described in more detail below with respect to FIG. 8.

Although method 200 has been described to be performed by platform 100, it should be understood that computing device 800 may be used to perform the various stages of method 200. Furthermore, in some embodiments, different operations may be performed by different networked elements in operative communication with computing device 800. For example, server 110 may be employed in the performance of some or all of the stages in method 200. Moreover, server 110 may be configured much like computing device 800.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200 may begin at starting block 205 and proceed to stage 210 where platform 100 may receive user content. For example, user content may be comprised of images, audio and video clips, and comments. In some embodiments, the clips may be limited to a specific time (e.g., 10 seconds). User content may further be comprised of hashtags. In further embodiments, the hashtags may be provided directly by the platform. For example, an application may automatically associate a hashtag with user content. The platform may provide the user with tools to modify and edit the provided content. For example, the platform may enable the user to apply filters, pan across an image, crop video and images, add or modify sound (e.g., cause the platform to play an audio clip as an image is displayed), arrange the presentation order of the content, etc. The content may be received from user 105, who may have a defined profile and account settings through platform 100.

From stage 210, where platform 100 receives user content, method 200 may advance to stage 220 where platform 100 may receive an advertisement campaign. For example, the advertisement campaign may be comprised of a plurality of parameters, including, but not limited to, for example, a campaign name, one or more hashtags associated with the advertising campaign, and an image, audio clip, and/or short video clip (i.e. ‘advertising content’). The advertising campaign may be specified by advertiser 115.

The advertisement campaign may further be defined with a number of ‘impressions,’ or times that the advertisement campaign may be provided to users viewing content associated with the advertising campaign (e.g., user content comprised of the hashtag(s) associated with the advertising campaign). Further, the advertising campaign may have defined impression restrictions. The impression restrictions may limit which users may provide content associated with the advertising campaign. In this way, the advertiser may select users most likely to provide content relevant to its advertising campaign.

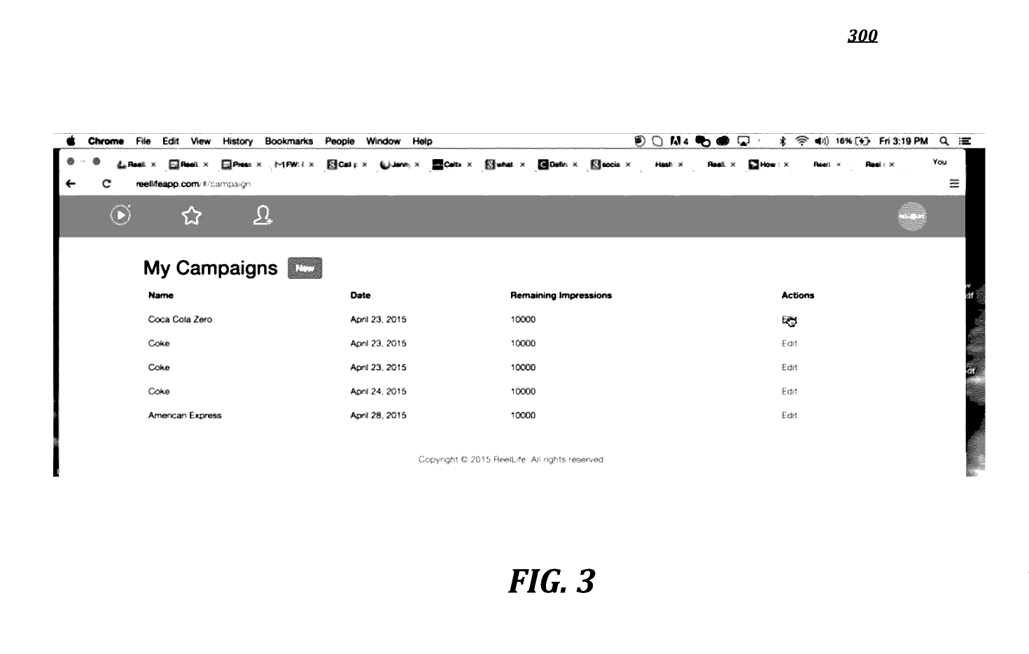

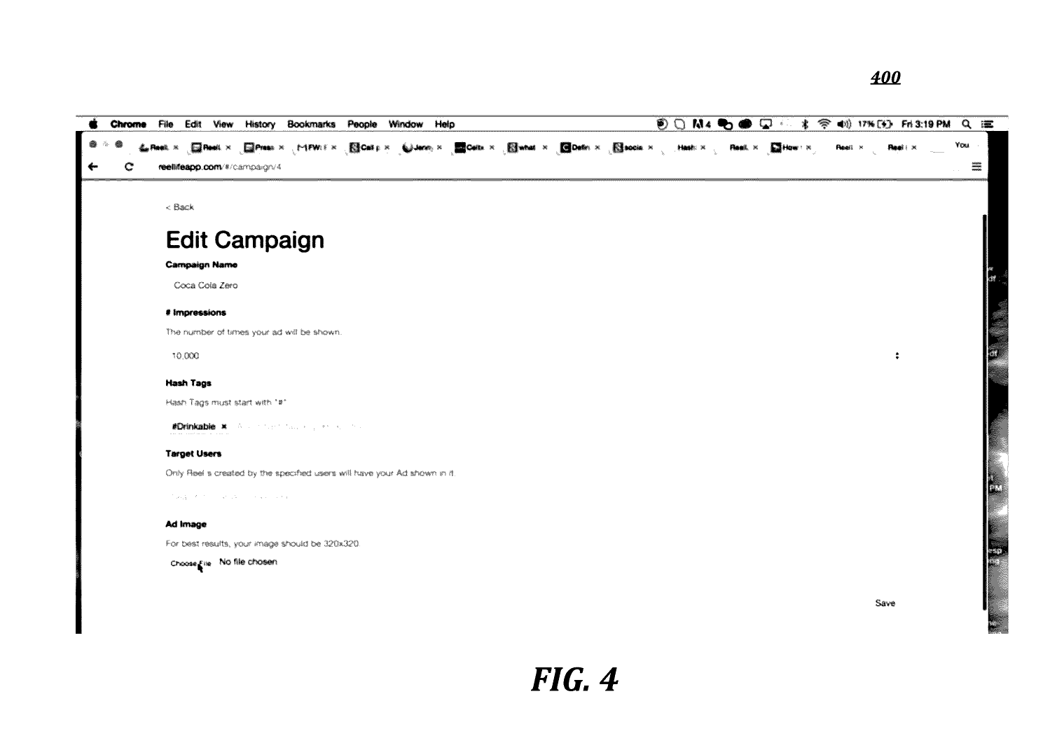

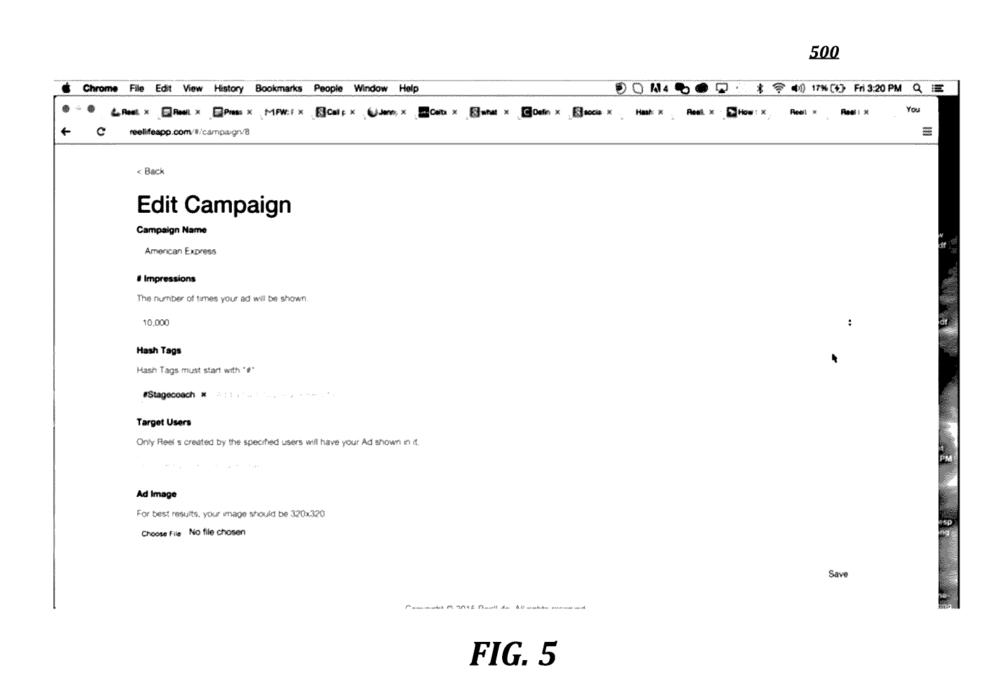

Moreover, the impression restrictions may limit which users receive content associated with the advertisement campaign. In this way, the advertiser may choose an ideal demographic to whom it desires to advertise. For example, impression restrictions may include, but not be limited to, specified usernames, one or more locations, a date range, an age range, a specified gender, and various other user demographics. In some embodiments, an advertiser may pay per impression or for the duration of the advertising campaign. FIG. 3 illustrates a dashboard 300 for displaying an advertiser's advertising campaigns. FIGS. 4-5 illustrate dashboards 400 and 500 for editing advertising campaigns.

Once platform 100 receives an advertising campaign in stage 220, method 200 may continue to stage 230 where platform 100 may integrate user content with the advertising content. In some embodiments, the integration may be hashtag based. For example, if a user provides three video clips, each with a duration of 10 seconds and a hashtag associated with an advertising campaign, the platform may create a video comprised of each of the user-provided content compiled with the advertising content, each of which are associated with the same or similar hashtags. In further embodiments, content may be interrupted by one or more integrations of advertising content. For example, the platform may receive, as user content, a 20-second video clip and integrate advertising content within the 20-second video clip (e.g., create a video comprising the first 10 seconds of the video clip, followed by one second of advertising content, followed by the last 10 seconds of the video clip). It should be understood that, although the present disclosures makes reference to hashtags, any content identifying tagging parameter can be used interchangeably or in conjunction with the hashtags. The platform may further provide any modifications to the content as provided by the content editing tools provided to the user.

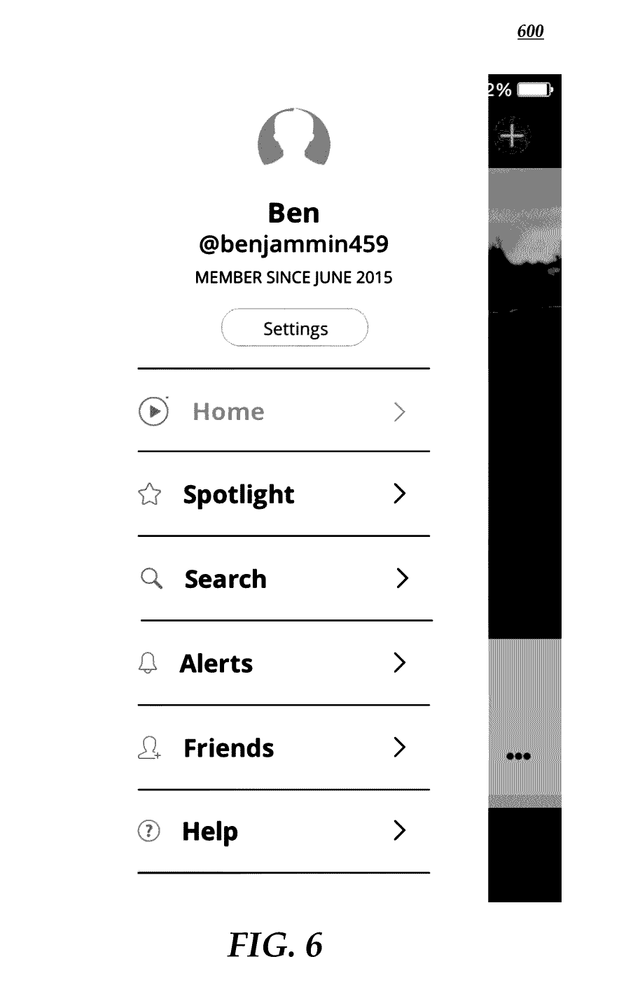

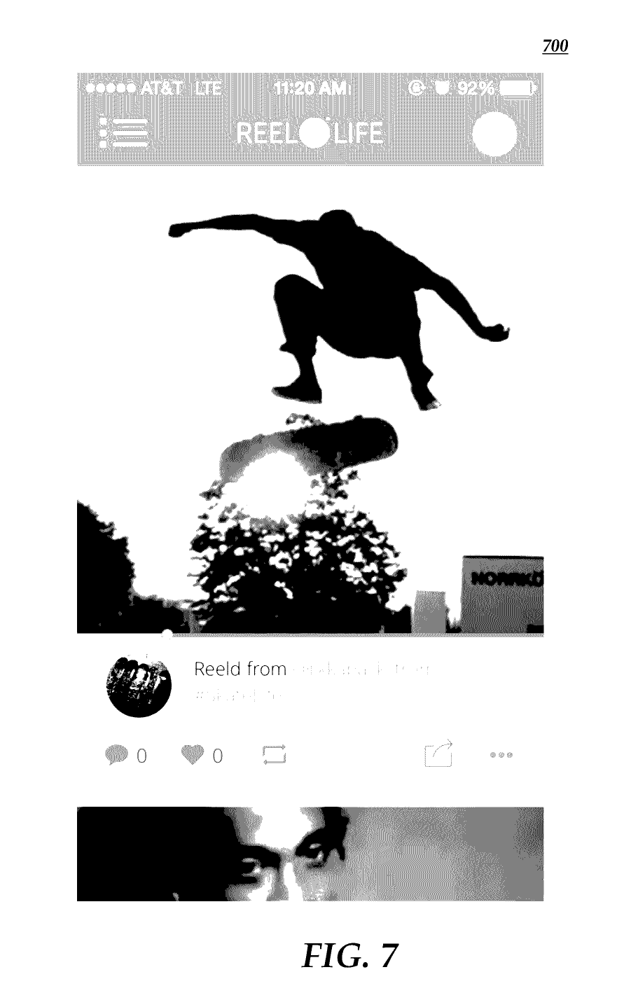

After platform 100 integrates user content with advertising content in stage 230, method 200 may proceed to stage 240 where platform 100 may provide the integrated content to the user network (‘viewers 120’). For example, platform 100 may provide the content to viewers who follow the user providing the content. In some embodiments, viewers may also be users who provide content. FIG. 6 illustrates a dashboard 600 for enabling users to view content from variety of sources. For example, platform 100 may provide viewers with a feed that shows content providing users that they follow. In some embodiments, platform 100 may provide viewers with featured content (‘spotlight’). In further embodiments, the platform may enable viewers to search content. In still further embodiments, the platform may provide a random selection of integrated content. FIG. 7 illustrates a feed of content 700 provided to a viewer. In additional embodiments, content may be provided to the user via a third-party interface. For example, Facebook may provide integrated content through its proprietary dashboard.

In some embodiments, each time advertising content is provided to a viewer (‘impression’), the platform may transfer funds from an account associated with the advertiser to an account associated with the user providing the content. Further, in some embodiments, each time an impression is made, an impression may be deducted from the number of impressions available to the advertising campaign. When there are no more impressions left in the advertising campaign, in some embodiments, the platform may discontinue integration and provision of the advertising content.

Once platform 100 provide the integrated content to the user network in stage 240, method 200 may then end at stage 250.

### IV. Platform Architecture

The audiovisual media and advertisement splicing platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although method 200 has been described to be performed by a computing device 800, it should be understood that, in some embodiments, different operations may be performed by different networked elements in operative communication with computing device 800.

Embodiments of the present disclosure may comprise a system having a memory storage and a processing unit. The processing unit coupled to the memory storage, wherein the processing unit is configured to perform the stages of method 200.

FIG. 8 is a block diagram of a system including computing device 800. Consistent with an embodiment of the disclosure, the aforementioned memory storage and processing unit may be implemented in a computing device, such as computing device 800 of FIG. 8. Any suitable combination of hardware, software, or firmware may be used to implement the memory storage and processing unit. For example, the memory storage and processing unit may be implemented with computing device 800 or any of other computing devices 818, in combination with computing device 800. The aforementioned system, device, and processors are examples and other systems, devices, and processors may comprise the aforementioned memory storage and processing unit, consistent with embodiments of the disclosure.

With reference to FIG. 8, a system consistent with an embodiment of the disclosure may include a computing device, such as computing device 800. In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include, for example, content splicing application 820. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable and non-removable media implemented in any method or technology for storage of information, such as computer readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., content splicing application 820) may perform processes including, for example, one or more of method 200's stages as described above. The aforementioned process is an example, and processing unit 802 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving a first content;
associating a first hashtag with the first content;
receiving a second content;
associating a second hashtag with the second content;
determining if the first hashtag and the second hashtag match; and
combining, when the first hashtag and the second hashtag match, the first content and the second content.

2. The method of claim 1, further comprising:
receiving an advertising campaign, the advertising campaign comprising:
the second content to be published,
the second hashtag associated with the second content, and
rules for publishing the second content.

3. The method of claim 2, wherein the second content comprises an advertisement.

4. The method of claim 2, wherein receiving the advertising campaign comprising rules for publishing the second content comprises receiving at least one of the following:
limitations on the amount of impressions the second content is permitted to receive, and
restrictions on viewers who are permitted to view the second content.

5. The method of claim 1, wherein receiving the first content comprises receiving at least one of the following: an audio, an image, and a video to be shared by a content sharing user.

6. The method of claim 5, wherein receiving the first comprises enabling the content sharing user to combine a plurality of content clips into the first content.

7. The method of claim 1, wherein associating the first hashtag with the first content comprises enabling a content sharing user to specify the first hashtag.

8. The method of claim 1, further comprising causing a publication of the combined content.

9. The method of claim 8, further comprising tracking a quantity of views of the published combined content.

10. The method of claim 9, further comprising calculating a payment to be made to the first content provider for each impression of the second content caused by the publication of the published combined content.

11. The method of claim 1, wherein combining the first content and the second content comprises splicing the second content into at least one of the following: a beginning of the first content, a middle of the first content, and an end of the first content.

12. A computer-readable medium having a set of instructions which when executed by a computer perform a method comprising:
receiving a first content;
associating at least one hashtag with the first content;
locating a second content associated with the at least one hashtag;
integrating the second content into the first content to form an integrated content; and
causing a publication of the integrated content.

13. The computer-readable medium of claim 12, further comprising:
receiving a definition of an advertising campaign, the advertising campaign definition comprising:
the second content to be published,
the at least one hashtag associated with the second content,
rules for integrating the second content, and
rules for publishing the second content.

14. The computer-readable medium of claim 13, wherein receiving the advertising campaign comprising rules for integrating the second content and publishing the integrated content comprises receiving at least one of the following:
a first restriction on combining the second content only with the first content when the first content was received from at least one specified users, and
a second restriction on publishing the integrated content to viewers of certain demographic types, the demographic types including at least one of the following: a location, an age, and a gender of the viewers.

15. The computer-readable medium of claim 12, wherein associating at least one hashtag with the first content comprises providing a provider of the first content with a listing of the at least one hashtag associated with the second content.

16. The computer-readable medium of claim 12, further comprising tracking a quantity of views of the published integrated content.

17. The computer-readable medium of claim 16, further comprising calculating a payment to be made to the first content provider for each impression of the second content caused by the publication of the published integrated content.

18. The computer-readable medium of claim 12, wherein integrating the second content into the second content comprises splicing the second content into at least one of the following: a beginning of the first content, a middle of the first content, and an end of the first content.

19. A method comprising:
receiving a first content;
associating a hashtag with the multimedia content;
determining whether the hashtag corresponds to an advertising campaign;
when the hashtag corresponds to the advertising campaign,
splicing a second content associated with the advertising campaign into the first content to generate a combined content; and
publishing the combined content.

20. The method of claim 19, wherein receiving the first content comprises receiving the first content from a third party platform and wherein publishing the combined content comprises publishing the combined content to the third party platform.
